(19) United States
(12) Patent Application Publication
(10) Pub. No.: US 2006/0085524 A1
(43) Pub. Date: Apr. 20, 2006

(54) Method and apparatus to drive network device in security by using unique identifier

(76) Inventor: Kang-hoon Lee, Yongin-si (KR)

Correspondence Address: Stanzione & Kim, LLP, 1st Fl., 1740 N St., NW, Washington, DC, 20036, US

(21) Appl. No.: 11/200,042

(22) Filed: Aug. 10, 2005

(30) Foreign Application Priority Data
Oct. 19, 2004 (KR) 2004-83538

(51) Int. Cl. G06F 15/177

(52) U.S. Cl. 709/220

(57) ABSTRACT

A method and an apparatus to drive a network device in security without memorizing a password or directly entering a user's identifier into the network device. The apparatus includes a communication terminal, a network device connected to the communication terminal via a network, and a unique ID removable storage media to store the unique identifier. The communication terminal includes a unique identifier generating unit to generate the unique identifier, a unique identifier recording unit to record the unique identifier on the unique ID removable storage media, and a driving instruction unit to transmit the unique identifier to the network device together with an instruction signal to drive the network device. The network device includes a unique identifier reader unit to read the unique identifier from the unique ID removable storage media, a verification unit to detect whether or not the transmitted unique identifier is identical to the read unique identifier, and a performing unit to drive the network device in response to the detected result. Accordingly, a user can use a public network device like her/his own device without an input key pad to receive a user's password. Also, it is not necessary to store a list of user passwords in a network device.

### CROSS-REFERENCE TO RELATED APPLICATIONS

This application claims the priority under 35 U.S.C. § 119 of Korean Patent Application No. 2004-83538, filed on Oct. 19, 2004, in the Korean Intellectual Property Office, the disclosure of which is incorporated herein in its entirety by reference.

### BACKGROUND OF THE INVENTION

1. Field of the Invention

The present general inventive concept relates to a method and a system to drive a network device in security, and more particularly, to a method and an apparatus to drive a network device in security without memorizing user authentication information, such as a password, or directly entering the user authentication information into the network device.

2. Description of the Related Art

FIG. 1 illustrates a conventional apparatus for driving a network device in security. Referring to FIG. 1, a network device 300, such as a network printer, and a host computer 100, in which a user 400 prepares a particular job, are connected with each other via a network. Herein, it is assumed that a plurality of users 400 publicly use the network device 300 at the same time.

If a user 400 wants to prevent other users from viewing or obtaining a desired document of the user 400, the network device 300 should not output the desired document until a desired time when the user 400 retrieves the desired document from the network device 300. That is, when the user 400 instructs network device 300 to output the desired document, the desired document should not be output until the desired time regardless of when the user 400 has instructed the network device 300 to output the desired document. In this case, the network device 300 should be provided with a security function.

For this purpose, according to a conventional network device 300 shown in FIG. 1, the user 400 should enter a password into the network device 300. A conventional method of driving the network device 300 shown in FIG. 1 in security will be described below.

Typically, a user 400 prepares a document in the host computer 100 and then instructs the network device 300 to output the document through the host computer 100. Meanwhile, information regarding a plurality of user's passwords has been recorded on a user list in the network device 300. After the user 400 instructs the network device 300 to output the document, the user 400 may move to a location of the network device 300 and then enter her/his password by using an input key pad provided on the surface of the network device 300. Since the network device 300 is made to operate only when the entered password is correct, other users can not get the instructing user's document before the instructing user 400 enters her/his password. Therefore, a user 400 can use the network device 300 without worrying about security. In other words, a user 400 can use the network device 300 like her/his own device even when the network device 300 is publicly used by a plurality of users 400.

However, the conventional method is inconvenient because the user 400 must memorize her/his password and enter the password into the network device 300 by pressing the input key pad.

In addition, information regarding the password of the user who wants to print a document must be previously recorded on a user list in the network device 300 in order to get the hard copies of the document from the network device 300. Therefore, a person whose password does not exist on the user list in the network device 300 can not use the network device 300 even in an urgent case.

Furthermore, an input key pad must be provided in the network device 300 to input the password.

### SUMMARY OF THE INVENTION

The present general inventive concept provides a method and an apparatus to drive a network device in security without memorizing user authentication information, such as a password, or directly entering the user authentication information into the network device.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an apparatus to drive a network device in security by using a unique identifier, including a communication terminal, a network device connected to the communication terminal via a network, and a unique ID removable storage media to store the unique identifier. The communication terminal includes a unique identifier generating unit to generate the unique identifier, a unique identifier recording unit to record the unique identifier on the unique ID removable storage media, and a driving instruction unit to transmit the unique identifier to the network device together with a signal to drive the network device. The network device includes a unique identifier reader unit to read the unique identifier from the unique ID removable storage media, a verification unit to detect whether the transmitted unique identifier is identical to the read unique identifier, and a performing unit to drive the network device in response to the detected result.

The foregoing and/or other aspects of the present general inventive concept are also achieved by providing a method of driving a network device by using a unique identifier, the method including driving the network device connected to a communication terminal via a network, generating a unique identifier in the communication terminal and transmitting the unique identifier to the network device, inputting a unique identifier into the network device and detecting whether or not the transmitted unique identifier is identical to the input unique identifier, and driving the network device when the transmitted unique identifier is identical to the input unique identifier.

The inputting of the unique identifier may include reading the unique identifier stored in a unique ID removable storage media connected to the network device.

The network device may be a printer. In this case, the transmission of the unique identifier may include generating the unique identifier in the communication terminal and transmitting the unique identifier together with output data, and the driving of the network device may include printing the output data in the network device when the input unique identifier is identical to the transmitted unique identifier.

The network device may be a scanner. In this case, the driving of the network device may include performing a scanning job in the network device when the input unique identifier is identical to the transmitted unique identifier and then transmitting the scanned image data to the communication terminal.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is an exemplary view of a conventional network printing apparatus;

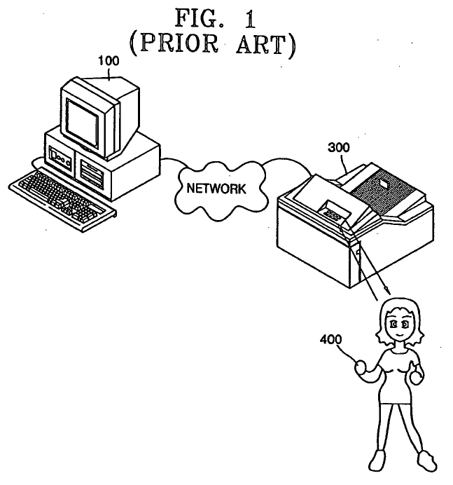

FIG. 2 is an exemplary view illustrating a network printing apparatus according to an embodiment of the present general inventive concept;

FIG. 3 is a block diagram illustrating an apparatus to drive a network device in security by using a unique identifier, according to an embodiment of the present general inventive concept;

FIG. 4 is a flow chart illustrating a method of driving a network printer in security by using a unique identifier, according to an embodiment of the present general inventive concept; and

FIG. 5 is a flow chart illustrating a method of driving a network scanner in security by using a unique identifier, according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

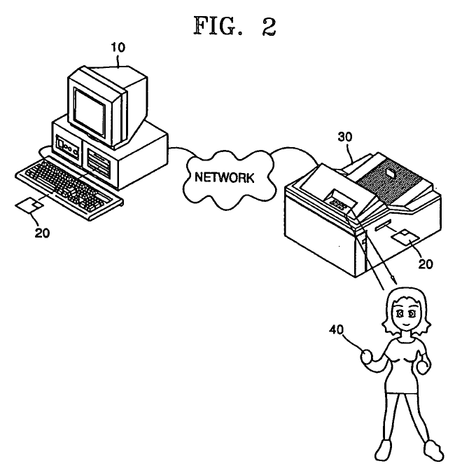

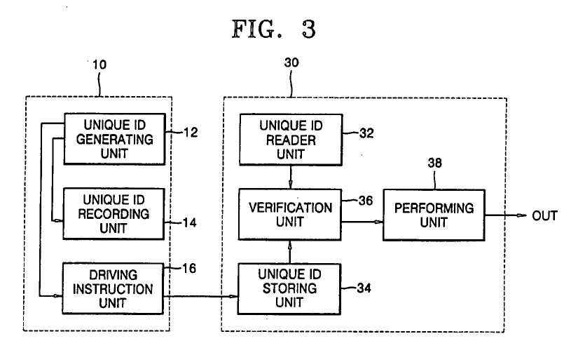

FIG. 2 is an exemplary view illustrating a network printing apparatus according to an embodiment of the present general inventive concept, and FIG. 3 is a block diagram illustrating an apparatus to drive a network device in security by using a unique identifier, according to an embodiment of the present general inventive concept.

The unique identifier can be a globally unique identifier (GUID), as described below, which is a structure having a 128-bit size and can be used worldwide regardless of time and location. Alternatively, a universally unique identifier (UUID) can be used. However, the meaning of the unique identifier is not limited thereto.

Referring to FIGS. 2 and 3, a host computer 10 is connected with a network device 30 through a network. The host computer 10 includes a unique ID generating unit 12, a unique ID recording unit 14, and a driving instruction unit 16. The network device 30 includes a unique ID reader unit 32, a unique ID storing unit 34, a verification unit 36, and a performing unit 38.

The unique ID generating unit 12 can generate a GUID corresponding to each job prepared by the host computer 10. In other words, each job corresponds to each GUID, respectively. The unique ID recording unit 14 records the generated GUID on a unique ID removable storage media 20, such as a floppy disk or a USB disk. In addition, the driving instruction unit 16 transmits a signal to instruct the network device 30 to operate to the network device 30 together with the generated GUID.

In the network device 30, the unique ID reader unit 32 reads the information recorded on the unique ID removable storage media 20 when the unique ID removable storage media 20 is connected to the network device 30. The unique ID storing unit 34 stores the GUID transmitted from the driving instruction unit 16 of the host computer 10.

The verification unit 36 detects whether or not the GUID read by the unique ID reader unit 32 is identical to the GUID stored in the unique ID storing unit 34. That is, when the GUID read by the unique ID reader unit 32 is identical to the GUID stored in the unique ID storing unit 34, the verification unit 36 selects a job corresponding to the GUID read from the unique ID reader unit 32 among a plurality of jobs transmitted to the network device 30, so that only the selected job can be processed. The performing unit 38 processes the selected job according to the signal transmitted by the driving instruction unit 16 of the host computer 10.

Accordingly, when a user 40 accomplishes a particular job in the host computer 10, the unique ID generating unit 12 generates a GUID corresponding to the accomplished job, and the generated GUID is recorded in the unique ID removable storage media 20 by the unique ID recording unit 14 and transmitted to the network device 30 by the driving instruction unit 16. The GUID transmitted by the driving instruction unit 16 is then stored in a unique ID storing unit 34 of the network device 30.

When a user 40 wants to obtain outcomes, i.e., hard copies of job, by driving the network device 30, the unique ID removable storage media 20 is connected to the network device 30. The GUID recorded on the unique ID removable storage media 20 connected to the network device 30 is read by the unique ID reader unit 32, and the read GUID is verified by the verification unit 36 by comparing the read GUID to the GUID stored in the unique ID storage unit 34 of the network device 30. As a result, the network device 30 starts to be driven only when the verification shows that the read GUID is authentic. That is, the network device 30 operates according to the signal transmitted by the driving instruction unit 16 of the host computer 10 when the GUID read from the unique ID removable storage media 20 is the same as the GUID stored in the unique ID storage unit 34 of the network device 30.

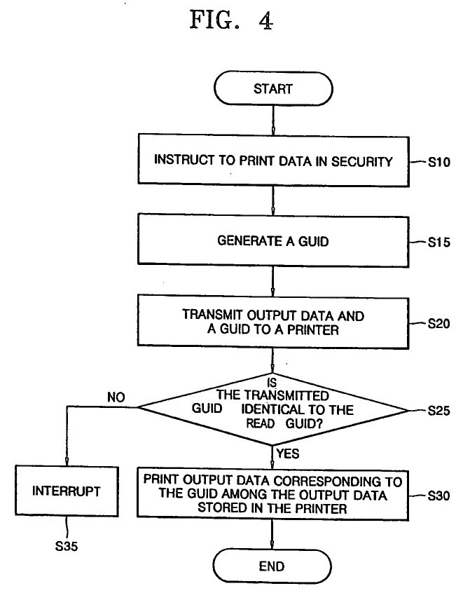

FIG. 4 is a flow chart illustrating a method of driving a network printer in security by using a unique identifier, according to an embodiment of the present general inventive concept. In FIG. 4, the network device 30 (FIG. 3) is exemplified by a network printer. The method illustrated in FIG. 4 will be described below with reference to FIGS. 2 and 3.

Referring to FIGS. 2-4, a user 40 instructs a security printing through a host computer 10 (operation S10), and a GUID is generated by the unique ID generating unit 12 of the host computer 10 (operation S15). The generated GUID is recorded in the unique ID removable storage media 20 which is portable by the user 40. The recorded GUID, data to be printed, and information relating to printing options are transmitted to the network printer 30 together (operation S20), and then stored in the network printer 30. The user 40 connects the unique ID removable storage media 20 to the GUID reader unit 32 provided in the network printer 30, and the recorded GUID is read from the connected unique ID removable storage media 20 to the GUID reader unit 32. Then, it is detected whether or not the read GUID is identical to the transmitted GUID (operation S25). If the read GUID is identical to the transmitted GUID, the data to be printed, which is stored in the network printer 30, is printed according to the information relating to the printing options (operation S30). Otherwise, all printing jobs are interrupted (operation S35).

The GUID is generated for each printing document whenever the host computer 10 instructs a security printing job. Therefore, each printing document has a different GUID even when a plurality of printing documents are prepared by one user 40.

For example, suppose that GUID values a1 and a2 are allocated to documents 1 and 2, respectively, prepared by a user A, and GUID values b3, b4 and b5 are allocated to documents 3, 4 and 5, respectively, prepared by another user B. In addition, suppose that all the documents 1 through 5 are security documents transmitted from the driving instruction unit 16 in the host computer 10 and stored in the same network printer 30, and the GUID values a1, a2, b3, b4 and b5 are separately stored in different floppy disks 20. In this case, the user B can print only the document 3 by instructing the network printer 30 to output the document 3 through the host computer 10 and then inserting the floppy disk 20 having the GUID value b3 recorded thereon into the network printer 30 when the user wants to print the document 3.

Accordingly, even when the user B instructs the network printer 30 to print the document 5 and then forgets it, the other user A can not view or obtain the document 5. The user A or B does not need to memorize the GUID a1, a2, b3, b4 and b5, but instead inserts one of the floppy disks 20 having the GUID a1, a2, b3, b4, or b5 corresponding to a desired one of the documents 1 through 5 into the network device 30.

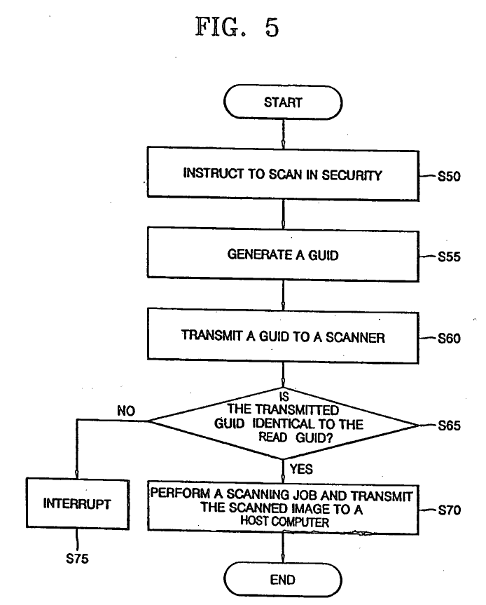

FIG. 5 is a flowchart illustrating a method of driving a network scanner in security by using a unique identifier, according to another embodiment of the present general inventive concept. In FIG. 5, the network device 30 (FIG. 3) is exemplified by a network scanner. The method illustrated in FIG. 5 will be described below with reference to FIGS. 2 and 3.

Referring to FIGS. 2, 3, and 5, a user 40 instructs a security scanning through a host computer 10 (operation S50), and a GUID is generated in the unique ID generating unit 12 of the host computer 10 (operation S55). The generated GUID is recorded in the unique ID removable storage media 20 and also transmitted to the network scanner 30 together with information relating to scanning options (operation S60). The transmitted GUID and the information relating to the scanning options are stored in the network scanner 30. Then, the user 40 can connect the unique ID removable storage media 20 to the GUID reader unit 32 provided in the network scanner 30. At this point, the GUID reader unit 32 reads the recorded GUID from the unique ID removable storage media 20, and the verification unit 36 of the network scanner 30 detects whether or not the read GUID is identical to the transmitted GUID (operation S65). If the read GUID is identical to the transmitted GUID, a prepared document on the network scanner 30 is scanned according to the transmitted information relating to the scanning options (operation 70). Then, the scanned image file is generated, and the scanned image file is transmitted to the host computer 10 of the user 40. Otherwise, all scanning jobs are interrupted (operation 75).

The document to be scanned can be prepared at the network scanner 30 at any time before a scanning operation is performed. As a result, even when the document is already prepared at the network scanner 30 such that other users may try to drive the network scanner 30 to scan the document, only a user possessing the unique ID removable storage media 20 storing the generated GUID corresponding to the document can drive the scanner to scan the document at a desired time.

A method and a system to drive a network device in security by using a unique identifier according to the embodiments of the present general inventive concept can be selectively applied in a network device when the instruction to drive the network device 30 from the host computer 10 includes a flag indicating that the network device 30 must be driven only by the unique identifier.

In other words, if the instruction to drive the network device 30 from the host computer 10 includes a flag indicating that the network device 30 must be driven only by the unique identifier, the network device 30 does not immediately respond to the instruction but waits in a standby state until the unique identifier is read from the unique ID removable storage media 20.

However, if the instruction to drive the network device 30 from the host computer 10 does not include a flag indicating that the network device 30 must be driven only by the unique identifier, the network device 30 may immediately respond to the instruction.

Although the unique ID removable storage media 20 is described above as being connectable to the host computer 10 and the network device 30, the present general inventive concept is not limited thereto. Alternatively, the unique ID removable storage media 20 may wirelessly communicate stored information with the host computer 10 and the network device 30.

According to various embodiments of the present general inventive concept, a user who forgets a designated password can use a public network device such as one provided at the user's own device. Also, it is possible to construct the network device without necessity of using an input key pad for entering a user's password and without storing a user's password inside of the network device.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A system to drive a network device in security by using a unique identifier, comprising:
a communication terminal;
a network device connected to the communication terminal via a network; and
a unique ID removable storage media to store the unique identifier,
wherein the communication terminal comprises a unique identifier generating unit to generate the unique identifier, a unique identifier recording unit to record the unique identifier on the unique ID removable storage media, and a driving instruction unit to transmit the unique identifier to the network device together with an instruction signal to drive the network device, and
wherein the network device comprises a unique identifier reader unit to read the unique identifier from the unique ID removable storage media, a verification unit to detect whether or not the transmitted unique identifier is identical to the read unique identifier, and a performing unit to drive the network device in response to the detected result.

2. The system according to claim 1, wherein the unique identifier comprises one of a globally unique identifier (GUID) and a universally unique identifier (UUID).

3. The system according to claim 1, wherein the unique ID removable storage media comprises one of a floppy disk and a USB storage device.

4. The system according to claim 1, wherein the unique ID removable storage media is connectable to the communication terminal and to the network device, and portable between the communication terminal and the network device.

5. The system according to claim 1, wherein the unique ID removable storage media is portable between the communication terminal and the network device to wirelessly communicate with the communication terminal and the network device.

6. The system according to claim 1, wherein when the verification unit detects that the transmitted unique identifier is identical to the read unique identifier, the performing unit drives the network device based on the instruction signal transmitted from the driving instruction unit of the communication terminal.

7. The system according to claim 1, wherein the network device comprises at least one of a network printer and a network scanner.

8. A network communication system comprising:
one or more host devices that can each generate a unique identifier corresponding to an instruction signal and to transmit the unique identifier and the corresponding instruction signal via a network and to store the unique identifier to a portable memory device; and
a network device to communicate with the one or more host devices over a network to receive and store the unique identifier from the one or more host devices and the corresponding instruction signal, to communicate with the portable memory device to input the unique identifier recorded therein, to compare the input unique identifier with the received unique identifier, and to operate according to the corresponding instruction signal when the input unique identifier is determined to be the same as the received unique identifier.

9. A network communication system comprising:
a host device to generate a unique identifier corresponding to a desired job, and including a first network connection unit to connect to a network to transmit the unique identifier and a first external memory receiving unit to record the unique identifier on a portable external memory;
a network device including a second network connection unit to connect to the network to receive the unique identifier transmitted from the host device, a second external memory receiving unit to read the unique identifier recorded on the portable memory, and an authentication unit to authenticate the read unique identifier by comparing the read unique identifier to the received unique identifier, wherein the network device performs the desired job when the read unique identifier is determined to be the same as the received unique identifier.

10. The network communication system according to claim 9, wherein the desired job comprises one of a printing job and a scanning job.

11. A host device connectable to a network device over a network, the host device comprising:
a unique ID generating unit to generate a unique ID corresponding to a job performable in the network device;
a driving instruction unit to transmit the generated unique ID and the corresponding job to the network device via the network; and
a unique ID recording device to record the generated unique ID to a portable external memory connectable to the network device to provide authorization to perform the corresponding job in the network device.

12. A network device connectable to one or more host devices over a network to perform jobs requested by the one or more host devices, the network device comprising:
a unique ID storing unit to store one or more first unique identifiers transmitted by the network hosts corresponding to one or more jobs requested by the network hosts;
a unique ID reader to input a second unique identifier from a portable external memory;
an authentication unit to compare the second unique identifier to the one or more first unique identifiers stored in the unique ID storing unit; and
a performing unit to perform one of the requested jobs when the corresponding one of the first unique identifiers is the same as the second unique identifier.

13. The network device according to claim 10, wherein the network jobs comprise at least one of network printing jobs and network scanning jobs.

14. A method of driving a network device by using a unique identifier, comprising:
sending an instruction signal to drive the network device from a communication terminal connected to the network device via a network;
generating a unique identifier corresponding to the instruction in the communication terminal and transmitting the unique identifier to the network device;
inputting a unique identifier into the network device and detecting whether or not the transmitted unique identifier is identical to the input unique identifier; and
driving the network device according to the instruction signal when the transmitted unique identifier is identical to the input unique identifier.

15. The method according to claim 14, wherein the inputting of the unique identifier includes reading the unique identifier from a unique ID removable storage media connected to the network device.

16. The method according to claim 14, wherein:
the network device comprises a printer;
the transmitting of the unique identifier includes generating the unique identifier in the communication terminal and transmitting the unique identifier together with output data; and
the driving of the network device includes printing the output data in the network device when the input unique identifier is identical to the transmitted unique identifier.

17. The method according to claim 14, wherein:
the network device is a scanner; and
the driving of the network device includes performing a scanning job in the network device when the input unique identifier is identical to the transmitted unique identifier and transmitting the scanned image data to the communication terminal.

18. A method of driving a network device communicating with at least one host device via a network, comprising:
receiving one or more first unique identifiers from the at least one host device corresponding to one or more jobs requested by the at least one host device;
inputting a second unique identifier from an external memory;
comparing the input second unique identifier with the received one or more first unique identifiers; and
performing one of the jobs when the corresponding one of the first unique identifiers is the same as the second unique identifier.

19. A method of driving a network device communicating with a host device via a network, comprising:
receiving an instruction signal and a corresponding unique identifier from the host device; processing the instruction signal to determine whether a security setting is requested;
when the security setting is requested, inputting an authentication identifier stored on a portable memory, comparing the authentication identifier with the received unique identifier, and driving the network device according to the instruction signal when the authentication identifier is the same as the received unique identifier; and
when the security setting is not requested, driving the network device according to the received instruction signal.

20. The method according to claim 19, wherein the processing of the instruction signal to determine whether the security setting is requested comprises:
determining whether the instruction signal includes a flag indicating that the security setting is requested.

21. A computer-readable recording medium containing a method of driving a network device, the method comprising:
sending an instruction signal to drive the network device from a communication terminal connected to the network device via a network;
generating a unique identifier corresponding to the instruction in the communication terminal and transmitting the unique identifier to the network device;
inputting a unique identifier into the network device and detecting whether or not the transmitted unique identifier is identical to the input unique identifier; and
driving the network device according to the instruction signal when the transmitted unique identifier is identical to the input unique identifier.

22. A computer-readable recording medium containing a method of driving a network device, the method comprising:
receiving one or more first unique identifiers from the at least one host device corresponding to one or more jobs requested by the at least one host device;
inputting a second unique identifier from an external memory;
comparing the input second unique identifier with the received one or more first unique identifiers; and
performing one of the jobs when the corresponding one of the first unique identifiers is the same as the second unique identifier.

23. A computer-readable recording medium containing a method of driving a network device, the method comprising:
receiving an instruction signal and a corresponding unique identifier from the host device; processing the instruction signal to determine whether a security setting is requested;
when the security setting is requested, inputting an authentication identifier stored on a portable memory, comparing the authentication identifier with the received unique identifier, and driving the network device according to the instruction signal when the authentication identifier is the same as the received unique identifier; and
when the security setting is not requested, driving the network device according to the received instruction signal.
